(19) United States
(12) Patent Application Publication
(10) Pub. No.: US 2022/0400495 A1
(43) Pub. Date: Dec. 15, 2022

(54) VIRTUAL MULTI-TRANSMISSION RECEPTION POINT/PANEL TRANSMISSION FOR URLLC

(71) Applicant: Nokia Technologies Oy, Espoo (FI)

(72) Inventors: Xiaomao MAO, Paris (FR); Zexian LI, Espoo (FI)

(21) Appl. No.: 17/762,320

(22) PCT Filed: Oct. 2, 2020
(86) PCT No.: PCT/IB2020/059284

§ 371 Date: Mar. 21, 2022

Related U.S. Application Data
(60) Provisional application No. 62/911,179, filed on Oct. 4, 2019.

(51) Int. Cl. H04W 72/12; H04W 72/14

(52) U.S. Cl. CPC H04W 72/1226; H04W 72/1273; H04W 72/14; H04W 72/1289

(57) ABSTRACT

A method, apparatus, and a computer-readable storage medium for a virtual multi-transmission reception point (TRP) or multi-panel transmission for ultra reliable low-latency communications (URLLC) are provided. In one example implementation, the method may include receiving, by a network node, at least two channel state information (CSI) reports from a user equipment (UE), the at least two CSI reports are received based at least on transmission and/or reception configuration transmitted to the UE and determining, by the network node, at least two beams for downlink transmission based on the at least two CSI reports. The method may further include transmitting, by the network node, a physical downlink control channel (PDCCH) to the UE, the PDCCH carrying scheduling information based on the at least two CSI reports and transmitting, by the network node, a physical downlink shared channel (PDSCH) to the UE, the PDSCH carrying at least two duplicate downlink data transmissions, each of the at least two duplicate downlink data transmissions is associated with one beam of the at least two beams.

### TECHNICAL FIELD

This description relates to wireless communications, and in particular, to ultra reliable low latency communications (URLLC).

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT), and may offer new types of mission-critical services. Ultra-reliable and low-latency communications (URLLC) devices may require high reliability and very low latency.

### SUMMARY

A method, apparatus, and a computer-readable storage medium for a virtual multi-transmission reception point (TRP) or multi-panel transmission for ultra reliable low-latency communications (URLLC) are provided.

In one example implementation, the method may include receiving, by a network node, at least two channel state information (CSI) reports from a user equipment (UE), the at least two CSI reports are received based at least on transmission and/or reception configuration transmitted to the UE and determining, by the network node, at least two beams for downlink transmission based on the at least two CSI reports. The method may further include transmitting, by the network node, a physical downlink control channel (PDCCH) to the UE, the PDCCH carrying scheduling information based on the at least two CSI reports and transmitting, by the network node, a physical downlink shared channel (PDSCH) to the UE, the PDSCH carrying at least two duplicate downlink data transmissions, each of the at least two duplicate downlink data transmissions is associated with one beam of the at least two beams.

In another example implementation, the method may include determining, by a user equipment (UE), at least two beams, the determination based at least on transmission and/or reception configuration received from a network node and transmitting, by the UE, at least two channel state information (CSI) reports based at least on the at least two beams and the configuration received from the network node. The method may further include receiving, by the UE, a physical downlink control channel (PDCCH) from the network node, the PDCCH carrying scheduling information based on the at least two CSI reports and receiving, by the UE, a physical downlink shared channel (PDSCH) from the network node, the PDSCH carrying at least two duplicate downlink data transmissions, each of the at least two downlink data transmissions is associated with one beam of the at least two beams.

### BRIEF DESCRIPTION OF THE DRAWINGS

FIG. 1 is a block diagram of a wireless network according to an example implementation.

FIG. 2 is a message flow diagram illustrating a virtual multi-TRP/panel transmission for URLLC, according to an example implementation.

FIG. 3 is a diagram illustrating a virtual multi-TRP/panel transmission for URLLC with a beam pair in time division, according to an example implementation.

FIG. 4 is a flow chart illustrating a virtual multi-TRP/panel transmission for URLLC at a gNB, according to an example implementation.

FIG. 5 is a flow chart illustrating a virtual multi-TRP/panel transmission at a UE, according to an example implementation.

FIG. 6 is a block diagram of a node or wireless station (e.g., base station/access point or mobile station/user device/UE), according to an example implementation.

### DETAILED DESCRIPTION

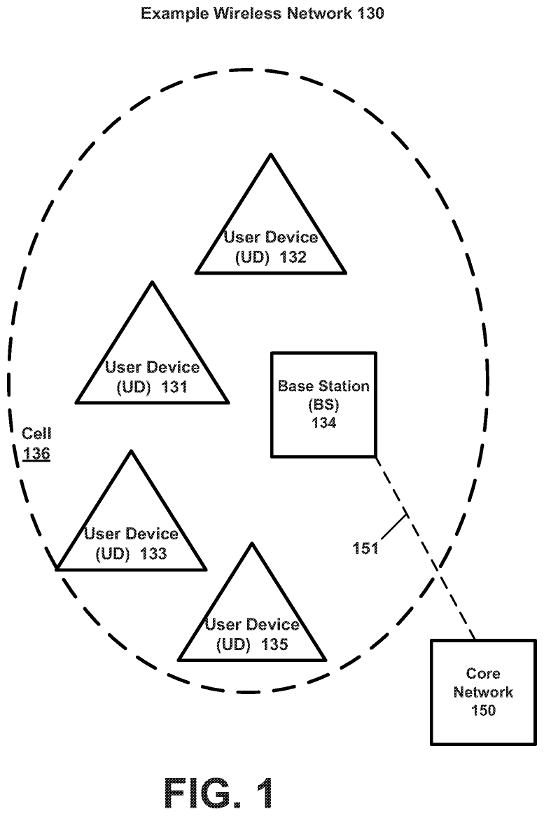

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e)Node B (eNB) may also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a 51 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra reliable low latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC or machine to machine communications) may, for example, be characterized by fully automatic data generation, exchange, processing and actuation among intelligent machines, with or without intervention of humans Enhanced mobile broadband (eMBB) may support much higher data rates than currently available in LTE.

Ultra reliable low latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example implementations may be applied to a wide variety of wireless technologies or wireless networks, such as LTE, LTE-A, 5G, IoT, MTC, eMTC, eMBB, URLLC, etc., or any other wireless network or wireless technology. These example networks, technologies or data service types are provided only as illustrative examples.

Multiple Input, Multiple Output (MIMO) may refer to a technique for increasing the capacity of a radio link using multiple transmit and receive antennas to exploit multipath propagation. MIMO may include the use of multiple antennas at the transmitter and/or the receiver. MIMO may include a multi-dimensional approach that transmits and receives two or more unique data streams through one radio channel. For example, MIMO may refer to a technique for sending and receiving more than one data signal simultaneously over the same radio channel by exploiting multipath propagation. According to an illustrative example, multi-user multiple input, multiple output (multi-user MIMIO, or MU-MIMO) enhances MIMO technology by allowing a base station (BS) or other wireless node to simultaneously transmit multiple streams to different user devices or UEs, which may include simultaneously transmitting a first stream to a first UE, and a second stream to a second UE, via a same (or common or shared) set of physical resource blocks (PRBs) (e.g., where each PRB may include a set of time-frequency resources).

Also, a BS may use precoding to transmit data to a UE (based on a precoder matrix or precoder vector for the UE). For example, a UE may receive reference signals or pilot signals, and may determine a quantized version of a DL channel estimate, and then provide the BS with an indication of the quantized DL channel estimate. The BS may determine a precoder matrix based on the quantized channel estimate, where the precoder matrix may be used to focus or direct transmitted signal energy in the best channel direction for the UE. Also, each UE may use a decoder matrix may be determined, e.g., where the UE may receive reference signals from the BS, determine a channel estimate of the DL channel, and then determine a decoder matrix for the DL channel based on the DL channel estimate. For example, a precoder matrix may indicate antenna weights (e.g., an amplitude/gain and phase for each weight) to be applied to an antenna array of a transmitting wireless device. Likewise, a decoder matrix may indicate antenna weights (e.g., an amplitude/gain and phase for each weight) to be applied to an antenna array of a receiving wireless device.

For example, according to an example aspect, a receiving wireless user device may determine a precoder matrix using Interference Rejection Combining (IRC) in which the user device may receive reference signals (or other signals) from a number of BSs (e.g., and may measure a signal strength, signal power, or other signal parameter for a signal received from each BS), and may generate a decoder matrix that may suppress or reduce signals from one or more interferers (or interfering cells or BSs), e.g., by providing a null (or very low antenna gain) in the direction of the interfering signal, in order to increase a signal-to interference plus noise ratio (SINR) of a desired signal. In order to reduce the overall interference from a number of different interferers, a receiver may use, for example, a Linear Minimum Mean Square Error Interference Rejection Combining (LMMSE-IRC) receiver to determine a decoding matrix. The IRC receiver and LMMSE-IRC receiver are merely examples, and other types of receivers or techniques may be used to determine a decoder matrix. After the decoder matrix has been determined, the receiving UE/user device may apply antenna weights (e.g., each antenna weight including amplitude and phase) to a plurality of antennas at the receiving UE or device based on the decoder matrix. Similarly, a precoder matrix may include antenna weights that may be applied to antennas of a transmitting wireless device or node.

Multiple transmission reception points (TRPs) and/or multiple panels at gNB and/or UE are generally needed to explore spatial domain diversity to support ultra reliable low latency communications (URLLC). This may be based on transmission of data (e.g., user data bits) replicated (or duplicated) from different TRPs or panels. This is currently being discussed in 3GPP MIMO work item (WI) for multi-TRP/panel for URLLC. However, it is not always possible to implement multiple TRPs and/or panels at gNB/UE due to cost, power efficiency, etc. For instance, when there is only one TRP and/or panel at gNB/UE, the available mechanisms would not provide ways for exploiting spatial diversity to enhance the reliability of URLLC. Therefore, the present disclosure proposes a virtual multi-TRP/panel transmission to achieve (e.g., realize) repetition in spatial domain and exploit the spatial domain diversity gain without additional hardware requirements (e.g., multiple TRPs/panels) at gNB/UE. In addition, depending on the implementation, time domain and/or frequency domain diversity/code domain diversity may be achieved simultaneously with spatial domain diversity.

In some implementations, for example, a gNB may transmit a physical downlink shared channel (PDSCH) with two beams of a beam pair within a scheduling period to a UE to realize spatial domain diversity. The beam pair may be selected by gNB based on channel state information (CSI) reports received from the UE.

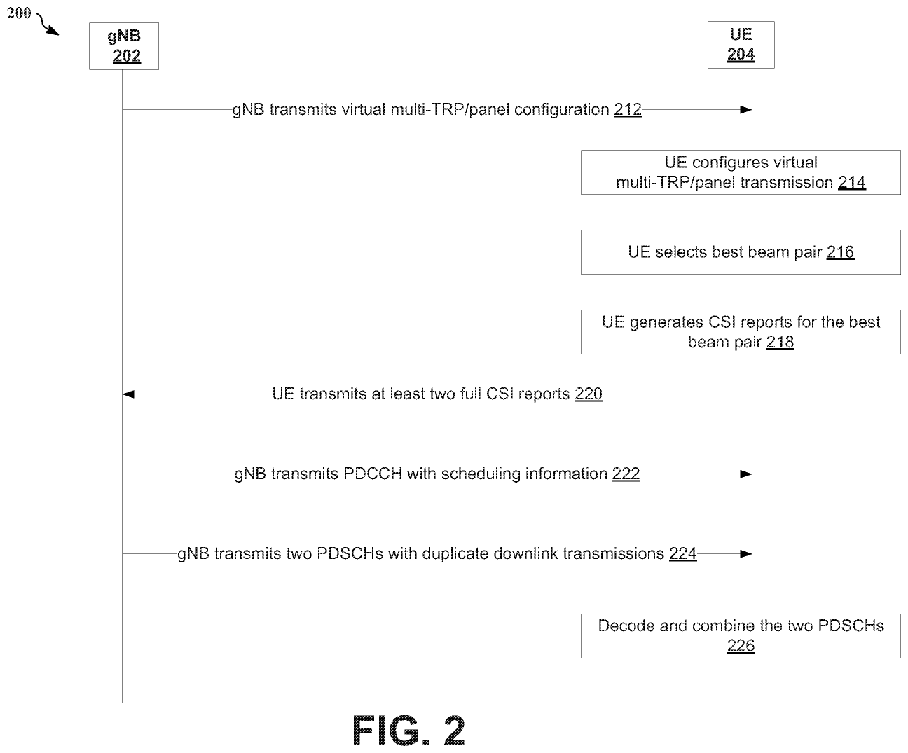

FIG. 2 is a message flow diagram 200 illustrating a virtual multi-TRP/panel transmission for URLLC, according to one example implementation. In an example implementation, FIG. 2 includes a network node, e.g., a gNB 202, and a UE, e.g., UE 204.

At 212, gNB 202 may transmit transmission and/or reception configuration to UE 204. In some implementations, for example, the transmission and/or reception configuration may comprise at least one of multi-transmission reception point (TRP) configuration, virtual multi-TRP configuration, or multi-panel configuration. In some implementations, for example, the transmission and/or reception configuration may be referred to as “configuration” in the present disclosure, may indicate to UE 204 that the UE may transmit at least two full CSI reports to the gNB. That is, the UE is allowed to transmit two (or more) full CSI reports to the gNB within a reporting instance. In some implementations, for example, one reporting instance may comprise a container carrying or including one or more CSI reports. The container may be scheduled to physical uplink control channel (PUCCH) resource at a time. All of the one or more CSI reports within the container may be estimated based on the same channel realization or condition. In some more implementations, for example, the configuration may also indicate other information, e.g., beam groups, number of maximum virtual TRPs, etc., to the UE.

In some implementations, for example, the configuration may be transmitted to the UE via at least one of a radio resource control (RRC) configuration, a media access control-control element (MAC-CE), a downlink control information (DCI), and/or a combination thereof.

At 214, UE 204 may configure virtual multi-TRP/panel transmission at the UE based on the configuration received from gNB 202. In some implementations, for example, UE 204, upon receiving of the configuration from gNB 204, the UE may activate virtual multi-TRP/panel transmission such that the UE is allowed to transmit multiple CSI reports to the gNB.

At 216, UE 204 may select a best beam pair. It should be noted that neighbor beams are generally avoided in the beam pair selection to ensure high reliability. Instead, the UE may explore angle property of the beams. That is, a first beam of a beam pair may be selected based on the best received power and the second beam of the beam pair is selected such that the second beam of the beam pair is perpendicular to the first beam of the beam pair and with sufficiently good quality of the received signals.

In an example implementation, UE 204 may select the best beam pair based on the following procedure: a) UE 204 may group all beams received from the gNB into “N” groups (N beam groups). In some implementations, for example, N may be inversely proportional to angular spread β (e.g., N=f(β)) at the UE. b) UE 204 may measure the best beam in each of the N groups based on received power measurements. In an example implementation, the received power measurements may be reference signal received power (RSRP) measurements. c) UE 204 may select the best two beams among the N best beams and select a beam pair.

For example, in an implementation, UE 204 may receive six beams (e.g., B1, B2, B3, B4, B5, and B6) from gNB 202. UE 204 may group the six beams into three groups, e.g., groups G1, G2, and G3, where B1 and B4 belong to G1, B2 and B6 belong to G2, and B3 and B5 belong to G3. UE 204 may measure the best beam in each of the three groups based on RSRP measurements. For example, B1 may be the best beam in G1, B2 may be the best beam in G2, and B3 may be the best beam in G3. UE 204 may then select beams B1 and B3 as the best beams (out of beams B1, B2, and B3) and form a beam pair (B1, B3). In some implementations, UE 204 may select more than two beams for potential DL reception.

In some implementations, for example, the beam pair may be applied in time division for FR2 where analog beamforming is generally assumed. For FR1, where hybrid or full digital beamforming applies in addition to time division, the beam pair could be applied in beam division too.

At 218, UE 204 may generate CSI reports for the best beam pair selected at 216. In some implementations, for example, UE 204 may generate a CSI report for each beam of the beam pair. The CSI reports generated by the UE may be full CSI reports which may include a CSI resource indicator (CRI) report, a channel quality indicator (CQI) report, a precoding matrix indicator (PMI) report or a portion of the PMI report, and a channel rank indicator (RI). It should be noted that the UE generates at least two full CSI reports based on the configuration received from the gNB. The configuration may indicate that the UE is allowed (e.g., configured, activated, etc.) to send two or more full CSI reports to the gNB. That is, in some implementations, UE 204 may be configured to send three (or more) full CSI reports to the gNB. The gNB may rely on these full CSI reports received to transmit a PDCCH with scheduling information and/or at least two PDSCHs carrying at least two duplicate downlink transmissions to the UE.

In some implementations, for example, simplified/compact reporting may be used to reduce overhead. For example, UE 204 may report one common CQI and RI, which may be the minimum CQI and RI between the two CSI reports, as shown below, such that when the gNB later transmits the PDSCH with duplicate downlink transmissions, the duplicate downlink transmissions may take the same amount of frequency domain resources making it much easier for the scheduler and additional savings may be achieved from rate-matching/padding as the two duplicate downlink transmissions are aligned in the frequency domain. In some more implementations, the duplicate downlink transmissions may be transmitted with two different MCS/RIs. In some more implementations, for the unmatched frequency domain resources, the bigger one may be allocated to guarantee high reliability transmission.

CQI=min(CQI₁,CQI₂),RI=min(RI₁,RI₂)

At 220, UE 204 may transmit the full CSI reports that are generated at 218 to gNB 202. It should be noted that the full CSI reports, at least two full CSI reports, are transmitted to the gNB based on the configuration received from the gNB at 212.

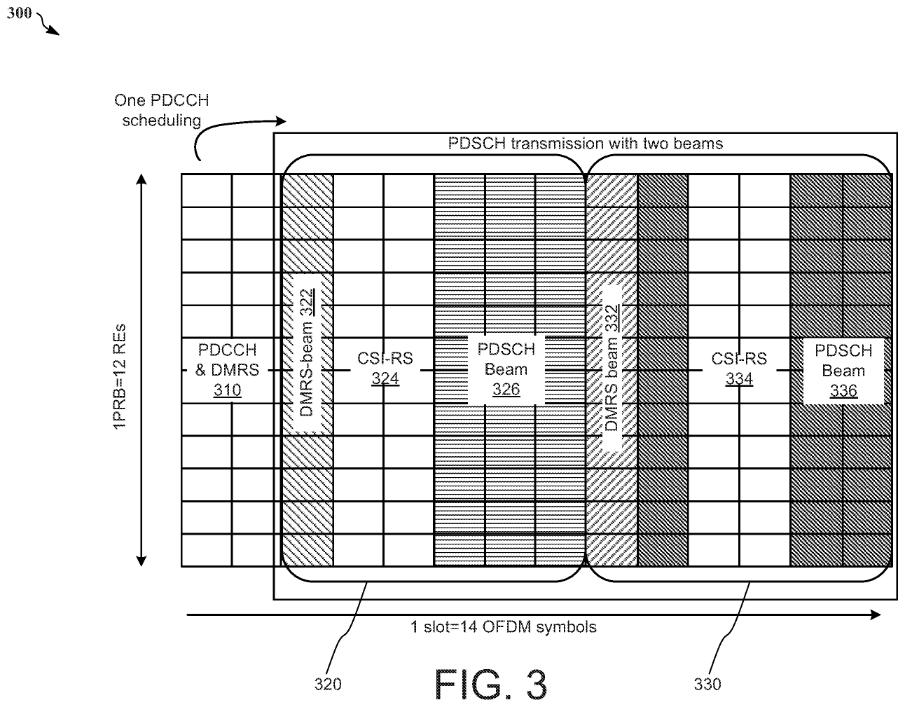

At 222, gNB 202 may transmit a PDCCH to UE 204. In some implementations, for example, the PDCCH (310 of FIG. 3) may carry scheduling information for the PDSCHs (320 and 330 of FIG. 3). The scheduling information for the PDSCHs may be based on the CSI reports received from the UE at 220.

At 224, gNB 202 may transmit a PDSCH to UE 204. In some implementations, for example, the PDSCH may comprise two PDSCHs (320 and 330) and carry duplicate downlink data transmissions (PDSCH beams 326 and 336). Each of the duplicate downlink data transmissions may be associated with one PDSCH beam transmitted from the gNB.

In some implementations, for example, the scheduling information transmitted in the PDCCH (310) may include a first scheduling information for a first PDSCH beam (e.g., PDSCH beam 326) and a second scheduling information for a second one (e.g., PDSCH beam 336), the first scheduling information being different or partially different from the second scheduling information.

In addition, in some more implementations, for example, the scheduling information, that may be based on CSI reports that are associated with a beam pair, for the two duplicate data transmissions may be signaled to the user equipment (UE) based on at least one of: a plurality of downlink control information (DCI) indicators in the PDCCH, a plurality of multiple transmission configuration indicator (TCI) states indicated in a DCI indicator in the PDCCH, or a TCI state indication with at least two quasi co-location (QCL) associations.

In some implementations, for example, each of the two duplicate data transmissions may include a DMRS associated with the duplicate data transmission. The DMRSs may be used by the UE for decoding the downlink transmissions.

In some implementations, for example, the duplicate data transmissions may carry identical information bits even though they may have different frequency domain allocations, time domain allocations, scrambling sequences, transmission configuration indicator (TCI) states, antenna ports, number of layers, modulation and coding schemes (MCS), or a combination thereof.

In some implementations, for example, gNB 202 may transmit the PDCCH (at 222) and the PDSCHs with duplicate downlink transmissions (at 224) within a scheduling period. That is, the PDCCH and PDSCHs are transmitted within the same scheduling period. The scheduling period may be a frame, subframe, slot, sub-slot, mini-slot, or a repetition of a number of repetitions during semi-persistent scheduling (SPS) or configured grant (CG) transmission.

In some implementations, upon receiving of the CSI reports of the beam pair, gNB scheduler may select and signal to the UE the applying beam pair based on collection of all beams from all UEs and multi-user pairing results. It should be noted that the UE reporting of a pair of two beams with full CSI reports may also facilitate the multi-user pairing with more precise channel information for each of the selected beams which may bring gains in system performance. The signaling is performed in a fast and dynamic way. In an example implementation, the legacy TCI state indication may be extended by sending one DCI containing two TCI states and each associated with one scheduling set as for MCS, antenna ports, and number of layers, etc. In order to save signaling overhead, in another example implementation may include signaling the two TCI states assuming the other scheduling indications are the same.

In some more implementations, for example, to realize the virtual multi-TRP/panel transmission based on the selected beam pair, gNB may divide the PDSCH transmission into two equal parts, each of which is beamed with one of the beams from the beam pair and carries one replica of the PDSCH transmission. If two scheduling indications (e.g., MCS, antenna ports and number of layers, etc.) are signaled and the two replicas employ different transmit block sizes, rate-matching and/or padding could be done in order to align the frequency domain resource allocation for the two replicas. In addition, to enable UE to demodulate the two replicas, DMRS may be transmitted at least twice within the scheduling period, each DMRS is associated with one of the beams from the selected beam pair. In some implementations, the association may apply the “closest in distance rule,” as shown in FIG. 3. That is, DMRS 322 is beamed with the same beam as the first part of PDSCH (326) and DMRS 332 is beamed with the same beam as the second part of the PDSCH (336). In case only one scheduling indication is signaled, the two parts of PDSCH may be two replicas with different beamforming beams.

At 226, UE 204 may decode and combine the PDSCHs transmitted by the gNB. In some implementations, for example, UE 204 may use the DMRSs, e.g., 322 and 332, for decoding the PDSCHs transmitted from the gNB.

Thus, the reliability requirements for URLLC may be met. It should be noted that the mechanisms described above/below apply for both downlink and uplink transmissions.

FIG. 3 is a diagram 300 illustrating a virtual multi-TRP/panel transmission for URLLC with a beam pair in time division, according to an example implementation.

In FIG. 3, downlink transmission with a beam pair applied in time division for FR2 may be used to illustrate the mechanism described above. In addition, a single sub-band transmission in one slot (e.g., as the scheduling granularity) without scrambling encoding may be assumed to differentiate from time/frequency/code domain repetition methods.

As illustrated in FIG. 3, in some implementations, for example, in a scheduling period regardless of the scheduling granularity, a PDCCH 310 may carry scheduling information associated with a beam pair and the following PDSCH may be transmitted with two replicas (or two duplicates), e.g., PDSCHs 320 and 330, each of which associates with one of the beams from the beam pair. This achieves spatial domain diversity by transmitting the PDSCHs with multiple beams without additional hardware requirements at either gNB or UE. In a scenario where a first beam from the beam pair is blocked, the second beam (e.g., the replica) of the beam pair may still be successfully transmitted/received while meeting the high reliability low latency requirements of URLLC. It should be noted that the replicas are scheduled with one PDCCH and carry the same PDSCH info bits. In addition, the proposed scheme may be applied to mini-slot transmission by breaking the mini-slot into two parts and a beam from the beam pair is transmitted in each part.

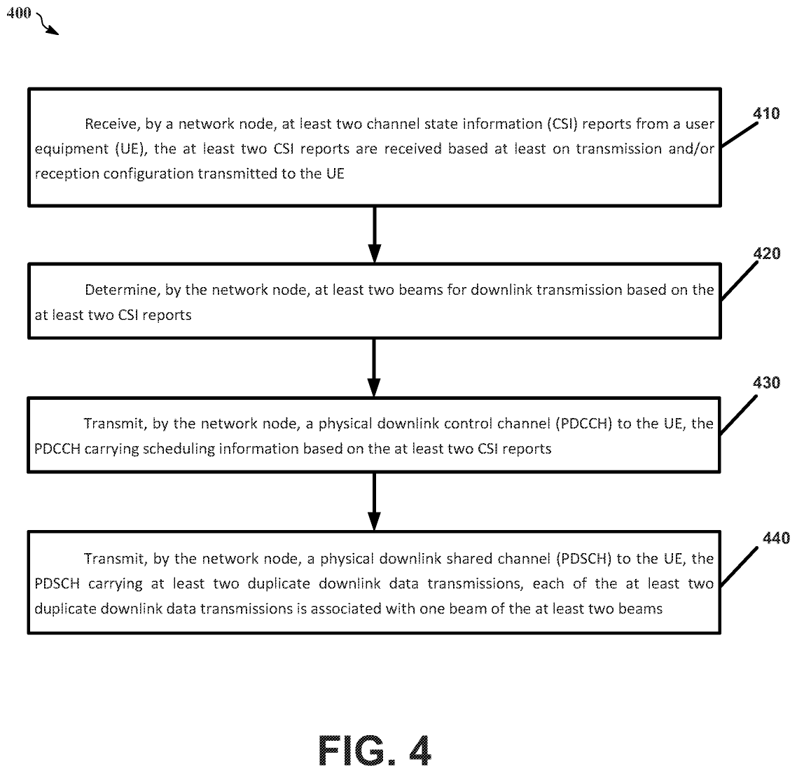

FIG. 4 is a flow chart 400 illustrating a virtual multi-TRP/panel transmission for URLLC at a gNB, according to an example implementation.

At block 410, a network node, e.g., gNB 202, may receive at least two channel state information (CSI) reports from a user equipment (UE). In some implementations, for example, the at least two CSI reports may be received based at least on transmission and/or reception configuration transmitted to the UE.

In an example implementation, the transmission and/or reception configuration may comprise at least one of multi-transmission reception point (TRP) configuration, virtual multi-TRP configuration, or multi-panel configuration. In another example implementation, gNB may receive the at least two CSI reports within a reporting instance.

At block 420, gNB 202 may determine at least two beams for downlink transmission based on the at least two CSI reports.

At block 430, gNB 202 may transmit a physical downlink control channel (PDCCH) to the UE. In some implementations, for example, the PDCCH may carry scheduling information based on the at least two CSI reports.

At block 440, gNB 202 may transmit a physical downlink shared channel (PDSCH) to the UE. In some implementations, for example, the PDSCH may carry at least two duplicate downlink data transmissions, each of the at least two duplicate downlink data transmissions is associated with one beam of the at least two beams.

Thus, as described above, gNB 202 may perform virtual multi-TRP/panel transmissions for URLLC.

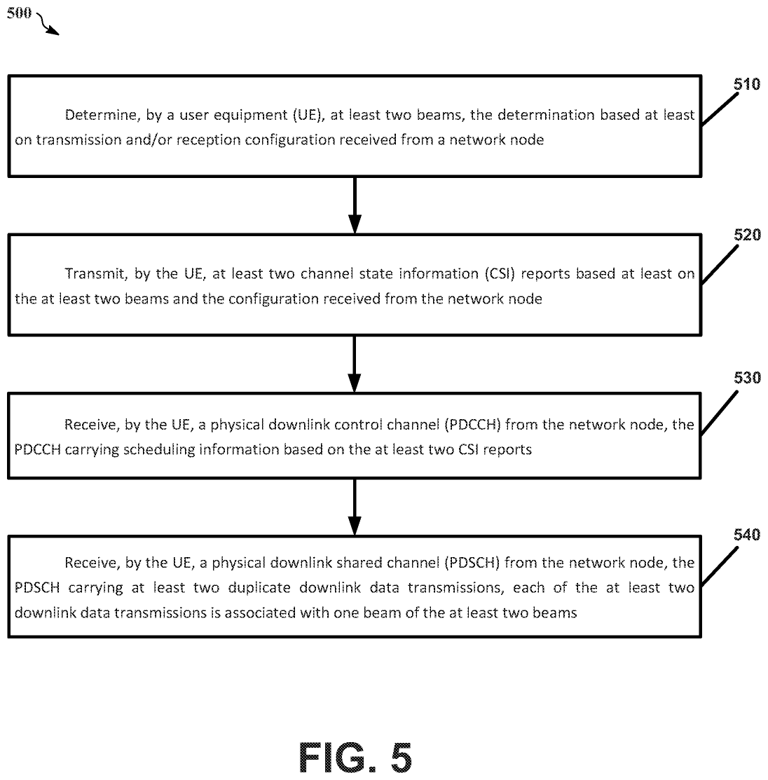

FIG. 5 is a flow chart illustrating a virtual multi-TRP/panel transmission at a UE, according to an example implementation.

At block 510, a user equipment, e.g., UE 204, may determine at least two beams. In some implementations, for example, the determining of the two beams may be based at least on transmission and/or reception configuration received from a network node, e.g., gNB 202.

At block 520, UE 204 may transmit at least two channel state information (CSI) reports. In some implementations, for example, the at least two channel state information (CSI) reports may be transmitted based at least on the at least two beams and the configuration received from gNB 202.

At block 530, UE 204 may receive a physical downlink control channel (PDCCH) from the network node. In some implementations, for example, the PDCCH may carry scheduling information based on the at least two CSI reports.

At block 540, UE 204 may receive a physical downlink shared channel (PDSCH) from the network node. In some implementations, the PDSCH may carry at least two duplicate downlink data transmissions, each of the at least two downlink data transmissions is associated with one beam of the at least two beams.

Thus, as described above, UE 204 may perform virtual multi-TRP/panel transmissions for URLLC.

Additional example implementations are described herein.

Example 1. A method of communications, comprising: receiving, by a network node, at least two channel state information (CSI) reports from a user equipment (UE), the at least two CSI reports are received based at least on transmission and/or reception configuration transmitted to the UE; determining, by the network node, at least two beams for downlink transmission based on the at least two CSI reports; transmitting, by the network node, a physical downlink control channel (PDCCH) to the UE, the PDCCH carrying scheduling information based on the at least two CSI reports; and transmitting, by the network node, a physical downlink shared channel (PDSCH) to the UE, the PDSCH carrying at least two duplicate downlink data transmissions, each of the at least two duplicate downlink data transmissions is associated with one beam of the at least two beams.

Example 2. The method of Example 1, wherein the transmitting of the PDCCH and the PDSCH is performed within a scheduling period.

Example 3. The method of any combination of Examples 1-2, wherein the scheduling period comprises at least one of: a frame; a subframe; a slot; a sub-slot; a mini-slot; or a repetition of a number of repetitions during semi-persistent scheduling (SPS) or configured grant (CG) transmission.

Example 4. The method of any combination of Examples 1-3, wherein the at least two CSI reports are received within the scheduling period.

Example 5. The method of any combination of Examples 1-4, wherein the transmission and/or reception configuration is transmitted via at least one of: a radio resource control (RRC) configuration; a media access control-control element (MAC-CE); or a downlink control information (DCI).

Example 6. The method of any combination of Examples 1-5, wherein each of the at least two duplicate data transmissions includes a demodulation reference signal (DMRS).

Example 7. The method of any combination of Examples 1-6, wherein the at least two duplicate data transmissions carry identical data information bits.

Example 8. The method of any combination of Examples 1-7, wherein the scheduling information includes at least one of: a first scheduling information for a first one of the at least two duplicate data transmissions; and a second scheduling information for a second one of the at least two duplicating data transmissions, wherein the first scheduling information is at least partially different from the second scheduling information.

Example 9. The method of any combination of Examples 1-8, wherein the scheduling information includes scheduling information for each of the at least two duplicate downlink data transmissions.

Example 10. The method of any combination of Examples 1-9, wherein differences between the first and the second scheduling information include at least one of: frequency domain resource allocation; time domain resource allocation; a scrambling sequence; transmission configuration indicator (TCI) states; antenna ports; number of layers; or modulation and coding schemes (MCS).

Example 11. The method of any combination of Examples 1-10, wherein the at least two channel state information (CSI) reports include at least one of: a CSI resource indicator (CRI) report; a channel quality indicator (CQI) report; a precoding matrix indicator (PMI) report or a portion of the PMI report; or a channel rank indicator (RI).

Example 12. The method of any combination of Examples 1-11, wherein the scheduling information based on the at least two CSI reports for the at least two duplicate data transmissions is signaled to the user equipment (UE) based on at least one of:

a plurality of downlink control information (DCI) indicators in the PDCCH; a plurality of multiple transmission configuration indicator (TCI) states indicated in a DCI indicator in the PDCCH; or a TCI state indication with at least two quasi co-location (QCL) associations.

Example 13. The method of any combination of Examples 1-12, further comprising: transmitting, by the network node, the transmission and/or reception configuration to the user equipment (UE).

Example 14. The method of any combination of Examples 1-13, wherein the transmission and/or reception configuration comprises at least one of multi-transmission reception point (TRP) configuration, virtual multi-TRP configuration, or multi-panel configuration.

Example 15. The method of any combination of Examples 1-14, wherein the at least two CSI reports are received within a reporting instance.

Example 16. An apparatus comprising at least one processor and at least one memory including computer program code, the at least one memory and the computer program code configured to, with the at least one processor, cause the apparatus to perform a method of any of Examples 1-15.

Example 17. An apparatus comprising means for performing a method of any of Examples 1-15.

Example 18. A method of communications, comprising: determining, by a user equipment (UE), at least two beams, the determination based at least on transmission and/or reception configuration received from a network node; transmitting, by the UE, at least two channel state information (CSI) reports based at least on the at least two beams and the configuration received from the network node; receiving, by the UE, a physical downlink control channel (PDCCH) from the network node, the PDCCH carrying scheduling information based on the at least two CSI reports; and receiving, by the UE, a physical downlink shared channel (PDSCH) from the network node, the PDSCH carrying at least two duplicate downlink data transmissions, each of the at least two downlink data transmissions is associated with one beam of the at least two beams.

Example 19. The method of Example 18, wherein the receiving of the PDCCH and the PDSCH is performed within a scheduling period.

Example 20. The method of any combination of Examples 18-19, wherein the scheduling period comprises at one of: a frame; a subframe; a slot; a sub-slot; a mini-slot; or a repetition of a number of repetitions during semi-persistent scheduling (SPS) or configured grant (CG) transmission.

Example 21. The method of any combination of Examples 18-20, wherein the at least two CSI reports are transmitted within the scheduling period.

Example 22. The method of any combination of Examples 18-21, wherein the transmission and/or reception configuration is received via at least one of: a radio resource control (RRC) configuration; a media access control-control element (MAC-CE); or a downlink control information (DCI).

Example 23. The method of any combination of Examples 18-22, wherein each of the at least two duplicate data transmissions includes a demodulation reference signal (DMRS).

Example 24. The method of any combination of Examples 18-23, wherein the at least two duplicate data transmissions carry identical data information bits.

Example 25. The method of any combination of Examples 18-24, wherein the scheduling information includes at least one of: a first scheduling information for a first one of the at least two duplicate data transmissions; and a second scheduling information for a second one of the at least two duplicating data transmissions, wherein the first scheduling information is at least partially different from the second scheduling information.

Example 26. The method of any combination of Examples 18-25, wherein the scheduling information includes scheduling information for the each of the at least two duplicate data transmissions.

Example 27. The method of any combination of Examples 18-26, wherein the scheduling information based on the at least two CSI reports for the at least two duplicate data transmissions are is based on at least one of: a plurality of downlink control information (DCI) indicators in the PDCCH; a plurality of multiple transmission configuration indicator (TCI) states indicated in a DCI indicator in the PDCCH; or a TCI state indication with at least two quasi co-location (QCL) associations.

Example 28. The method of any combination of Examples 18-27, wherein the at least two QCL associations include two CSI resource indicators (CRIs), and wherein the selection of the two CRIs at the UE comprises: grouping a plurality of CSI resources into a plurality of groups; identifying at least one CRI with a highest quality in each group of the plurality of groups; and selecting at least two CRIs with highest quality from the identified at least one CRI to schedule UE transmission.

Example 29. The method of any combination of Examples 18-28, wherein a number of the plurality of groups is inversely proportional to angular spread at the user equipment (UE).

Example 30. The method of any combination of Examples 18-29, wherein a highest quality CSI resource in each group is identified based on received power measurement.

Example 31. The method of any combination of Examples 18-30, further comprising: receiving, by the UE, the transmission and/or reception configuration from the network node.

Example 32. The method of any combination of Examples 18-31, wherein the transmission and/or reception configuration comprises at least one of multi-transmission reception point (TRP) configuration, virtual multi-TRP configuration, or multi-panel configuration.

Example 33. The method of any combination of Examples 18-32, wherein the at least two CSI reports are transmitted within a reporting instance.

Example 34. An apparatus comprising at least one processor and at least one memory including computer program code, the at least one memory and the computer program code configured to, with the at least one processor, cause the apparatus to perform a method of any of Examples 18-33.

Example 35. An apparatus comprising means for performing a method of any of Examples 18-33.

Example 36. A non-transitory computer readable medium comprising program instructions stored thereon for performing a method according to any of Examples 1-15 or performing a method according to any of Examples-33.

Example 37. A computer program comprising instructions stored thereon for performing a method according to any of Examples 1-15 or performing a method according to any of Examples 18-33.

Example 38. A computer readable medium storing a program of instructions, execution of which by a processor configuring an apparatus to at least perform a method according to any of Examples 1-15 or to at least perform a method according to any of Examples 18-33.

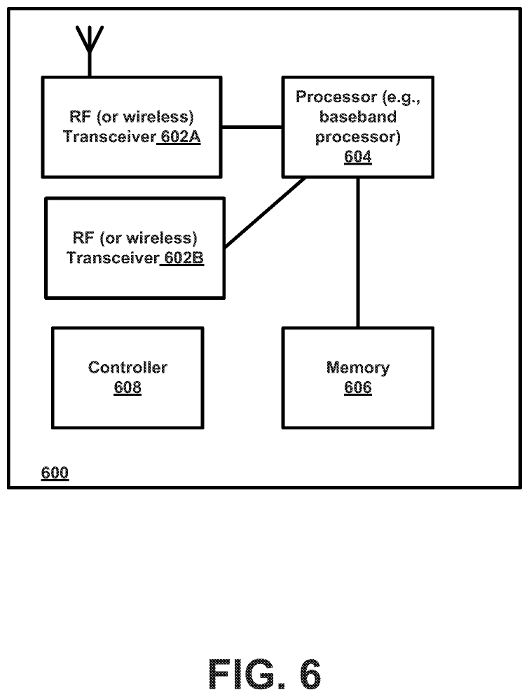

FIG. 6 is a block diagram of a wireless station (e.g., user equipment (UE)/user device or AP/gNB) 600 according to an example implementation. The wireless station 600 may include, for example, one or more RF (radio frequency) or wireless transceivers 602A, 602B, where each wireless transceiver includes a transmitter to transmit signals and a receiver to receive signals. The wireless station also includes a processor or control unit/entity (controller) 608 to execute instructions or software and control transmission and receptions of signals, and a memory 606 to store data and/or instructions.

Processor 604 may also make decisions or determinations, generate frames, packets or messages for transmission, decode received frames or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602A/602B, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602A/602B together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6, such as controlling input/output devices (e.g., display, keypad), and/or may execute software for one or more applications that may be provided on wireless station 600, such as, for example, an email program, audio/video applications, a word processor, a Voice over IP application, or other application or software.

In addition, a storage medium may be provided that includes stored instructions, which when executed by a controller or processor may result in the processor 604, or other controller or processor, performing one or more of the functions or tasks described above.

According to another example implementation, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

The aspects are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Implementations of the various techniques described herein may be implemented in digital electronic circuitry, or in computer hardware, firmware, software, or in combinations of them Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers Implementations may also be provided on a computer readable medium or computer readable storage medium, which may be a non-transitory medium Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

1-38. (canceled)

39. An apparatus, comprising:
at least one processor, and
at least one memory including computer program code,
the at least one memory and the computer program code configured to, with the at least one processor, cause the apparatus at least to:
determine at least two beams, the determination based at least on transmission and/or reception configuration received from a network node;
transmit at least two channel state information reports based at least on the at least two beams and the configuration received from the network node;
receive a physical downlink control channel from the network node, the physical downlink control channel carrying scheduling information based on the at least two channel state information reports; and receive a physical downlink shared channel from the network node, the physical downlink shared channel carrying at least two duplicate downlink data transmissions, each of the at least two duplicate downlink data transmissions is associated with one beam of the at least two beams.

40. The apparatus of claim 39, wherein the receiving of the physical downlink control channel and the physical downlink shared channel is performed within a scheduling period.

41. The apparatus of claim 40, wherein the scheduling period comprises at one of:
a frame;
a subframe;
a slot;
a sub-slot;
a mini-slot; or
a repetition of a number of repetitions during semi-persistent scheduling or configured grant transmission.

42. The apparatus of claim 41, wherein the at least two channel state information reports are transmitted within the scheduling period.

43. The apparatus of claim 39, wherein the transmission and/or reception configuration is received via at least one of:
a radio resource control configuration;
a media access control-control element; or
a downlink control information.

44. The apparatus of claim 39, wherein each of the at least two duplicate data transmissions includes a demodulation reference signal.

45. The apparatus of claim 39, wherein the at least two duplicate data transmissions carry identical data information bits.

46. The apparatus of claim 39, wherein the scheduling information includes at least one of:
a first scheduling information for a first one of the at least two duplicate data transmissions; and
a second scheduling information for a second one of the at least two duplicating data transmissions, wherein the first scheduling information is at least partially different from the second scheduling information.

47. The apparatus of claim 39, wherein the scheduling information includes scheduling information for the each of the at least two duplicate data transmissions.

48. The apparatus of claim 39, wherein the scheduling information based on the at least two channel state information reports for the at least two duplicate data transmissions is based on at least one of:
a plurality of downlink control information indicators in the physical downlink control channel;
a plurality of multiple transmission configuration indicator states indicated in a downlink control information indicator in the physical downlink control channel; or
a transmission configuration indicator state indication with at least two quasi co-location associations.

49. The apparatus of claim 48, wherein the at least two quasi co-location associations include two channel state information resource indicators, and wherein selection of the two channel state information resource indicators at the apparatus comprises the at least one memory and the computer program code configured to, with the at least one processor, cause the apparatus to:
group a plurality of channel state information resources into a plurality of groups;
identify at least one channel state information resource indicator with a highest quality in each group of the plurality of groups; and
select at least two channel state information resource indicators with highest quality from the identified at least one channel state information resource indicator to schedule UE transmission.

50. The apparatus of claim 49, wherein a number of the plurality of groups is inversely proportional to angular spread at the apparatus.

51. The apparatus of claim 39, wherein a highest quality channel state information resource in each group is identified based on received power measurement.

52. The apparatus of claim 39, wherein the at least one memory and the computer program code configured to, with the at least one processor, cause the apparatus to:
receive the transmission and/or reception configuration from the network node.

53. The apparatus of claim 39, wherein the transmission and/or reception configuration comprises at least one of multi-transmission reception point configuration, virtual multi-transmission reception point configuration, or multi-panel configuration.

54. The apparatus of claim 39, wherein the at least two channel state information reports are transmitted within a reporting instance.

55. An apparatus, comprising:
at least one processor, and
at least one memory including computer program code,
the at least one memory and the computer program code configured to, with the at least one processor, cause the apparatus at least to:
receive at least two channel state information reports from a user equipment, the at least two channel state information reports are received based at least on transmission and/or reception configuration transmitted to the user equipment;
determine at least two beams for downlink transmission based on the at least two channel state information reports;
transmit a physical downlink control channel to the user equipment, the physical downlink control channel carrying scheduling information based on the at least two channel state information reports; and
transmit a physical downlink shared channel to the user equipment, the physical downlink shared channel carrying at least two duplicate downlink data transmissions, each of the at least two duplicate downlink data transmissions is associated with one beam of the at least two beams.

56. The apparatus of claim 55, wherein the transmitting of the physical downlink control channel and the physical downlink shared channel is performed within a scheduling period.

57. The apparatus of claim 55, wherein each of the at least two duplicate data transmissions includes a demodulation reference signal.

58. A method of communications, comprising:
determining, by a user equipment, at least two beams, the determination based at least on transmission and/or reception configuration received from a network node;
transmitting, by the user equipment, at least two channel state information reports based at least on the at least two beams and the configuration received from the network node;
receiving, by the user equipment, a physical downlink control channel from the network node, the physical downlink control channel carrying scheduling information based on the at least two channel state information reports; and
receiving, by the user equipment, a physical downlink shared channel from the network node, the physical downlink shared channel carrying at least two duplicate downlink data transmissions, each of the at least two duplicate downlink data transmissions is associated with one beam of the at least two beams.
